(19) United States
(12) Patent Application Publication
(10) Pub. No.: US 2008/0285294 A1
(43) Pub. Date: Nov. 20, 2008

(54) DECORATIVE LIGHTING DEVICES

(76) Inventor: Michael Y. Kim, Anaheim Hills, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/058,393

(22) Filed: Mar. 28, 2008

Related U.S. Application Data
(60) Provisional application No. 60/908,651, filed on Mar. 28, 2007.
(60) Provisional application No. 60/946,324, filed on Jun. 26, 2007.

(51) Int. Cl. F21S 4/00; F21S 9/04

(52) U.S. Cl. 362/487; 362/145

(57) ABSTRACT

Disclosed herein are lighting devices which may include one or more sheets with lighting components on the sheet or sheets, and also a mounting device for securing the lighting device to a surface. The lighting devices are typically configured to position the sheet or sheets in a deployed position wherein the lighting components are substantially visible, and a retracted position wherein the lighting components are substantially obscured. The disclosed lighting devices may move the sheet between the retracted and deployed positions by winding or unwinding the sheet. The disclosed lighting devices may be configured for attachment to a building or vehicle. In some examples, two of the disclosed lighting devices may be connected together. The connection may provide for substantially joint movement of the two lighting devices. Some disclosed lighting devices may also include a picture that may or may not be fully or partially formed by the lighting components.

### RELATED APPLICATIONS AND CLAIM OF PRIORITY

This application is related to, and claims benefit under 35 U.S.C. § 119(e) to, U.S. Provisional Patent Application No. 60/908,651, filed on Mar. 28, 2007 and to U.S. Provisional Patent Application No. 60/946,324, filed on Jun. 26, 2007, each of which is incorporated in its entirety by reference herein.

### BACKGROUND OF THE INVENTIONS

1. Field of the Inventions

The disclosed inventions relate generally to decorative devices and particularly to decorative devices with lighting.

2. Description of the Related Art

Lighting devices are often employed as decorations on holidays such as Christmas or on other special occasions. Such lighting devices can be suspended from or attached to houses or used to decorate or enhance other structures, such as marketing displays, store fronts, offices, restaurants, cars, recreational vehicles, trucks, etc. In some applications, the lighting devices may require extensive time and effort to assemble and hang or otherwise connect to the structure supporting them, such as a house. The lighting devices may also need to be stored during the remainder of the year in another location. In addition, the installation may involve climbing on ladders and roofs, creating some risk to the persons performing the installation, many of whom are not trained to do so safely.

### SUMMARY OF THE INVENTIONS

Many embodiments of decorative lighting devices disclosed herein provide significant advantages. For example, in some instances, the disclosed inventions can eliminate or reduce the labor and/or danger of installing lighting devices on houses or other structures. In addition, due to the diminished labor and inconvenience, the lighting may be used more frequently, such as for parties, holiday gatherings, and other special occasions throughout the year that normally would not be elaborate enough to justify hanging up decorative lighting.

In some embodiments of the inventions disclosed herein, the lighting devices can be installed on a structure in a permanent or semi-permanent manner and remain in place for repeated uses without the need to disassemble, remove, and/or store the lighting devices in other locations.

In some embodiments of the inventions disclosed herein, some components of the lighting device can be contained within a housing that is attached to the structure that supports the lighting, such as fascia that runs along the roof of a home. The device's housing can be partially or completely hidden from outside view by, for example, positioning it behind or underneath roof fascia board. An illuminated portion of the lighting device can then be selectively and temporarily withdrawn from the lighting device's housing while the housing remains obscured behind the fascia board or other structure.

For example, a string of lights or multiple strings of lights can be rolled up in the housing and then unwound to selectively expose the lights. The lights can be in the form of icicles (e.g., relatively long, thin, substantially vertical strands), substantially horizontal lines, scallops, mesh lights, individual lights, screens of lights or pixels, sheets of lights or pixels, other patterns of lights, etc. In a sheet embodiment, the lights can, for example, be embedded on a light, dark, colored, or clear flexible vinyl or fabric that can have patterns of lighting devices. The lights themselves can be of many different types, such as LEDs, LCDs, incandescent bulbs, fluorescent bulbs, etc.

A device's housing into which the lighting components are wound can be, for example, a substantially cylindrical tube made of, for example, plastic or PVC material that obscures the lights from view. An inner component, such as a rod with end caps, can be positioned substantially within the housing. The inner component can be configured to rotate while allowing the outer housing to remain in a substantially fixed position for mounting purposes. The inner component can be attached to the lighting components to enable the lighting components to be selectively wound up or otherwise drawn into the housing. If the lighting components are embedded on a vinyl, fabric, or other flexible component, such flexible component can be completely or partially rolled into the housing. In addition to temporarily and/or selectively obscuring the lighting components from view, the housing can protect the lighting components from damage or wear caused by outdoor exposure.

In some embodiments, the housing, or a component thereof, can be rotated along its longitudinal axis manually by an extended instrument that permits a person to obscure or reveal the lighting from a distance. In an example of a tool for manually winding or unwinding the lighting components, one end of such tool is held by a user and another end has a connector, such as a hex wrench, that can interface with and assist in rotating a rod or other structure mounted to or within the housing. In some cases, the tool can be extendable or retractable to reach different heights on a roof or other structure. The tool can also be contoured, such as with a bend in an end to make it easier to hold (on the proximal end) or easier to connect with the rotating structure in the housing (on the distal end).

In some embodiments, the lighting can also be wound or unwound remotely by a motor. The motor can be controlled by switches connected with wires and/or a wireless transceiver or other electrical connection, or a computer processing device, such as a personal computer or a dedicated processor. The motor and/or the lights can also be connected to a timing device to permit the lights to be revealed and/or powered up on certain days or at certain times of day or night. The lighting devices, including the motor and/or power to the lights, can also be adapted through appropriate electronics to operate in a synchronized manner with music.

The housing in which the lighting components are mounted can be substantially cylindrical, rectangular, or shaped in some other way. In some embodiments, the housing has one surface, such as the front surface, to obscure the lighting, and another surface, such as a rear surface or upper surface, to provide a support for components to attach the lighting to the house or other structure. In some embodiments, a hook or plates with holes can be attached or made integral with the housing to assist in receiving screws, nails, staples, or other connectors to attach the housing in an appropriate manner to the house. As used herein, the term “house” should be understood to include and encompass any other structure to which the lighting devices may be attached.

In some embodiments, such as embodiments with a substantially rectangular housing, a front cover configured on hinges can be manually or electrically opened and closed in a selective manner. When the cover is closed, at least some lighting components are obscured from view. When the cover is open, at least some of the lighting components that were obscured from view in the closed position, are now exposed and viewable. This configuration may be provided as an alternative, or in addition to, the exposing or obscuring of lighting devices in other ways as described or referred to herein.

### BRIEF DESCRIPTION OF THE DRAWINGS

FIG. 1 illustrates an example of a house with various embodiments of lighting devices mounted thereon.

FIG. 2 illustrates an embodiment of a lighting device.

FIG. 3 illustrates an embodiment of a lighting device mounted behind roof fascia on a house.

FIG. 4 illustrates an embodiment of a lighting device and a manual lighting actuator tool.

FIG. 5 illustrates an embodiment of two lighting devices configured to connect to one another.

FIG. 6 illustrates embodiment of two lighting devices before and after coupling.

FIG. 7 illustrates an embodiment of a lighting device including a picture.

### DETAILED DESCRIPTION OF THE PREFERRED EMBODIMENTS

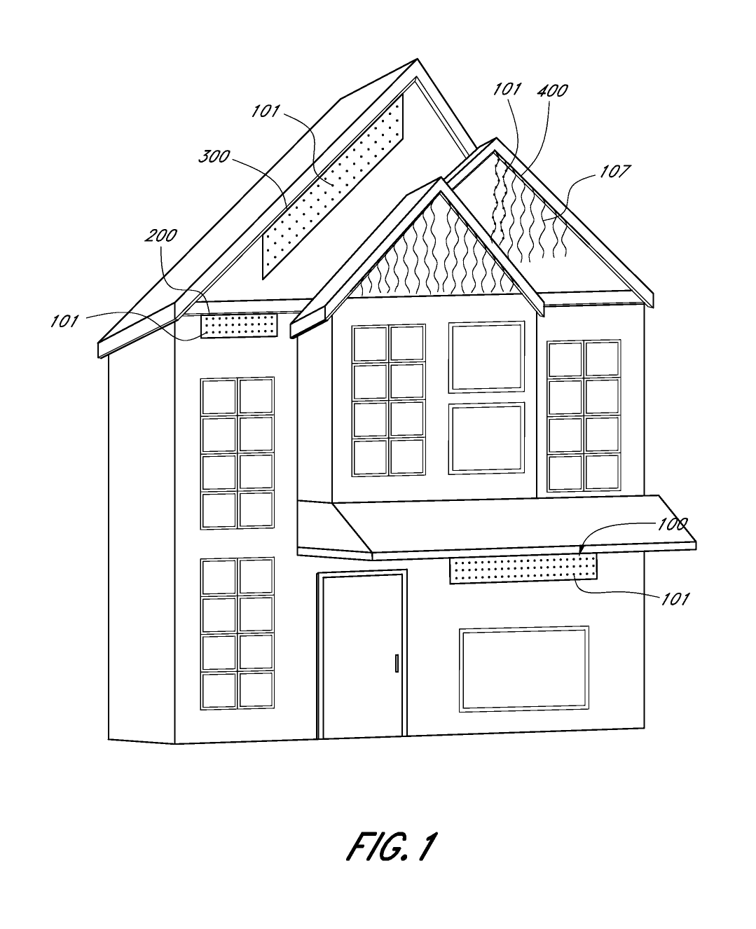

FIG. 1 illustrates an example of a building such as a house with various embodiments of lighting devices mounted thereon. A first lighting device 100 is mounted beneath the roof line above the porch of the house. Although the device 100 is shown mounted on the outside of the house, it can also be mounted on the inside of the house, as can any of the other devices disclosed herein. The lighting device 100 can include a sheet 108 that can be made of vinyl or fabric, for example, with lighting components 101 of any type mounted thereon. The lighting components 101 can be sparsely spaced as shown or more closely spaced, such as with the edges of each lighting component 101 positioned close to each other, or even touching, to create the impression of a continuous or uninterrupted sheet of light. The electrical leads from such lighting components 101 can be positioned behind or within the supporting sheet 108. The sheet 108 can also be configured as a screen similar to a television or a computer screen with small pixels capable of displaying animations in fine detail. The lighting device 100 can be relatively long, such as greater than about 4 feet, or between about 4 feet and about 6 feet, or greater than about 6 feet. In some embodiments, a length of approximately 96 inches can be used for a long lighting device component.

A second lighting device 200 is shown (in FIG. 1) in an example of a position on a second story roof line. The second lighting device 200 can be similar in composition and structure to the first lighting device 100. As illustrated, the second lighting device 200 is shorter than the first lighting device 100 to fit in a shorter region of the house. For example, the second lighting sheet 200 can have a length of less than about 4 feet, such as between about 3 feet and about 4 feet, or less than about 3 feet. However, the second lighting device could be any size that would appropriately fit under the second story roof line of the house.

A third lighting device 300 is shown in an example of a position on the upper roof line of the home mounted at an angle. In the illustrated example, the third lighting device 300 has a length similar to the first lighting device 100, and in some embodiments, could be even longer to fit the very long space under the roof line. The housing on the third lighting device can have brackets (not shown) that are angled in the back or on the top so as to facilitate connection or hanging of the housing at an angle, as shown. In addition, in some embodiments, the lighting components 101 can be aligned as shown to give the appearance of a substantially vertical alignment of lights even though the sheet is not mounted in a vertical orientation.

A fourth lighting device 400 is shown mounted on or underneath an upper section of the roof line. The fourth lighting device 400 has strands of lights 107, rather than a sheet of lights, as shown in the first 100, second 200, and third 300 lighting devices. Devices of the type of the fourth lighting device 400 can come in various different lengths and sizes, such as those shown for the lighting sheets 108, to fit various structures or lengths of components on a house. Furthermore, in some embodiments the individual strands of lights 107 may be of differing lengths. As used herein, any references to lighting “sheets,” “screens,” “strands,” or similar terms also can be applied to other types of lighting components, such as strings of light, strands of lights, netting, individual lighting components, or other types of lighting components and configurations disclosed herein or otherwise known to those of skill in the art.

By providing lighting devices in various lengths and sizes, and mounting devices such as brackets that are adapted for hanging or otherwise securing the devices on substantially horizontal, substantially vertical, or angled surfaces, a series of such devices can be positioned around a house to fit various surfaces on the house without requiring the lighting devices to be modified or cut, and without resulting in excess cords or components that may need to be removed, obscured, or wound up.

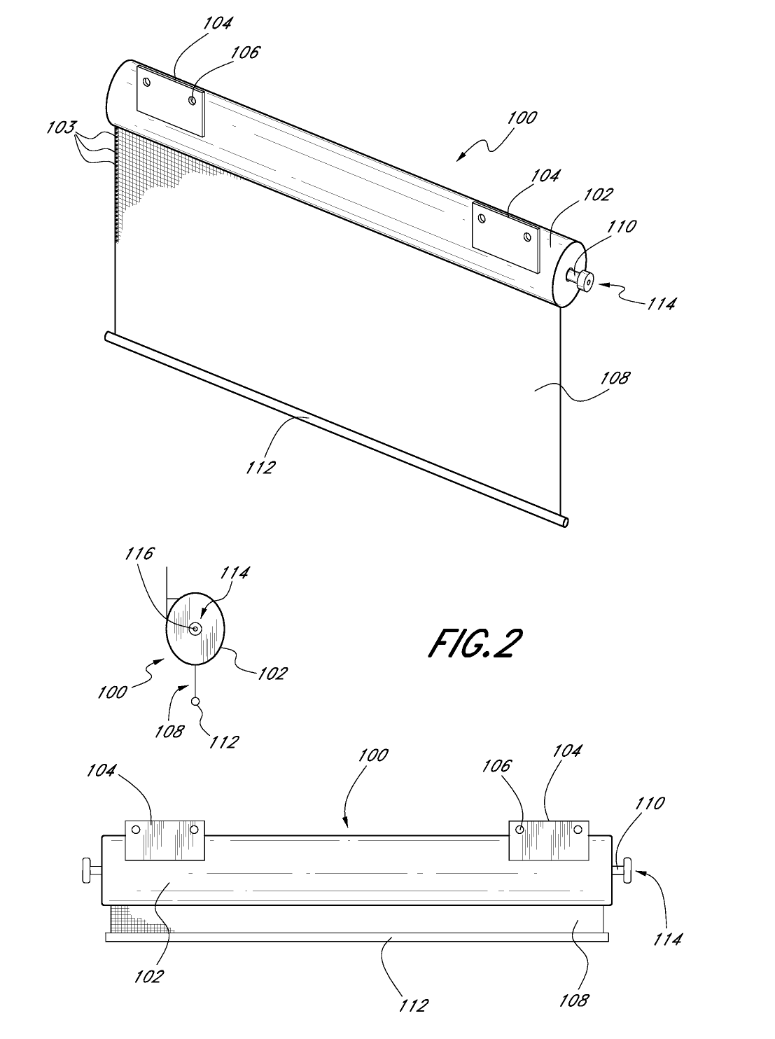

FIG. 2 illustrates an example of the first lighting device 100. The device 100 can include a housing 102. Mounting devices such as brackets 104 can be attached to the housing 102. In the illustrated embodiment, the mounting brackets 104 are plates with holes 106 for receiving nails, screws, staples, or the like, to temporarily or permanently affix or hang the housing 102 to a support surface. The bottom end of the mounting brackets 104 can be attached to the housing 102. The mounting devices can be constructed, oriented, or otherwise configured in many different ways with many different types of connections.

The lighting device 100 can also include a lighting sheet 108. The lighting sheet can have a first end (not shown) attached to a rod 110 mounted within the housing in a rotatable manner. When the rod 110 is turned, the lighting sheet 108 can wind around the rod 110 and move substantially or entirely into and be substantially or entirely contained by the housing 102. In some embodiments, a rod 112 is provided along a lower edge of the lighting sheet 108 to provide weight and rigidity to keep the sheet hanging down in a substantially unwrinkled manner during use, and to prevent the sheet from irretrievably retracting into the housing 102 during storage.

The sheet 108 can include a plurality of lighting components 103, which can be the same as or similar to the components 101 of FIG. 1. In the embodiment illustrated in FIG. 2, the lighting components 103 are positioned close to each other. As shown, the lighting components 103 cover only a specific portion of the sheet 108 for simplicity, but the lighting components 103 can cover any portion, or substantially all, or all of the sheet 103 in various positions, orientations, and densities. In addition, lighting components 103 of different colors, or lighting components 103 capable of changing colors, can be provided on the sheet 108.

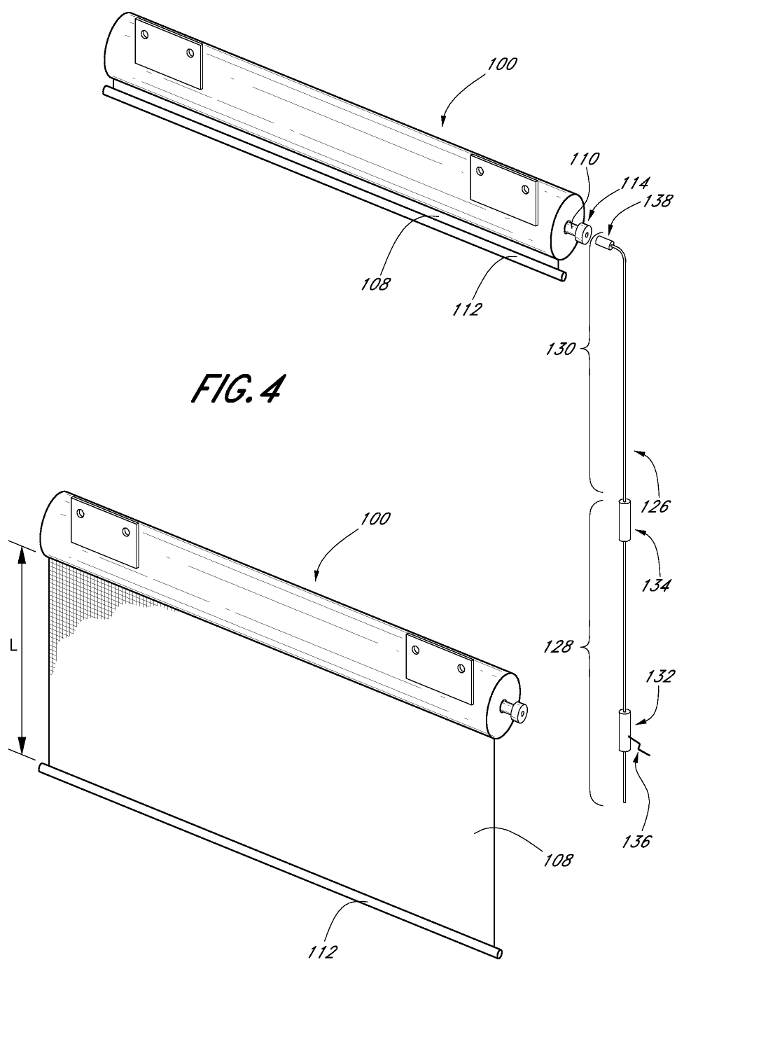

A tool port 114 can be positioned on a first end of the housing 102. The tool port 114 can include a coupling structure such as depression 116 to receive, attach to, or otherwise couple with a tool, such as a manual tool (see, e.g., FIG. 4) to actuate the lighting sheet 108. In the illustrated embodiment, when the tool port 114 is rotated, it in turn rotates the rod 110, which in turn winds or unwinds the lighting sheet 108. Many other types of interfaces and mechanisms can be provided for obscuring or revealing the lighting sheet 108. Such interfaces and mechanisms can include manual or electrical components. For example, an electrical motor can be used to roll up or down the lighting sheet and lighting components.

Mounting brackets 104 can be positioned at various points and angles on the housing 102. Mounting brackets 104 can also have many different shapes and sizes. For example, one or more mounting brackets 104 can be narrow and longer and/or be mounted on one or both ends of the housing 102, which can be particularly helpful in mounting the housing 102 underneath a rafter tail.

In some embodiments, the lighting sheet 108 or other lighting structure can be manually switched out or replaced with one or more other types of decorative lighting devices, such as those disclosed elsewhere in this application. This switching process can be performed to replace a worn or damaged lighting structure or to allow selective lighting choices for different holidays or other special occasions.

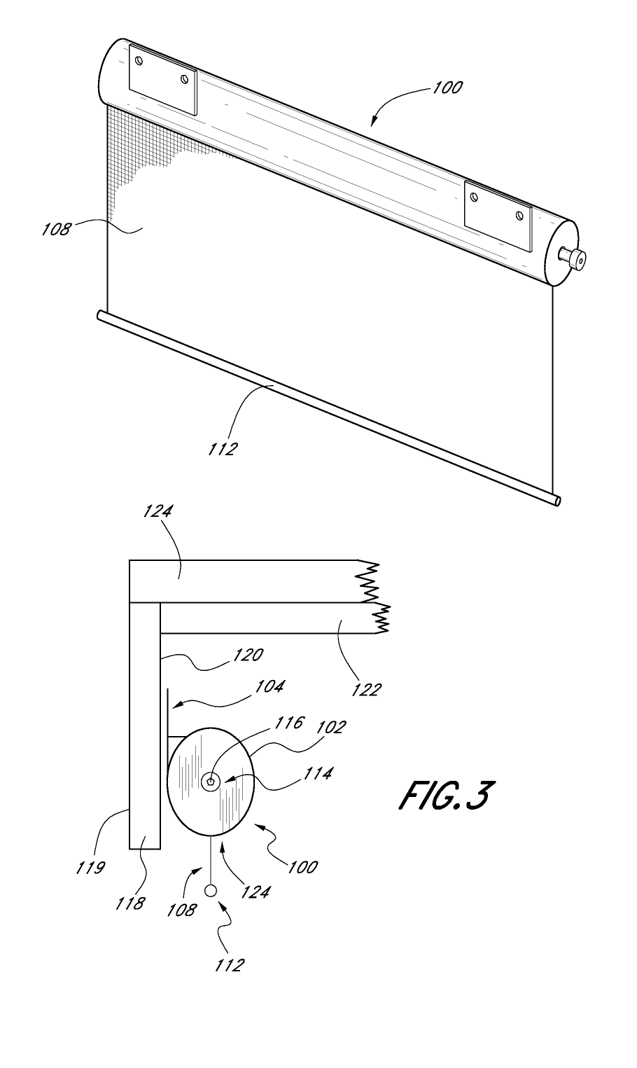

FIG. 3 illustrates an example of the lighting device 100 mounted behind roof fascia on a house. As illustrated, a roofing fascia board 118 can have a first surface 119 viewable by a person facing and viewing the front of the house and a second surface 120 that is not generally viewable by a person facing and casually viewing the front of the house. The roof on the house may also include a rafter tail 122 and a roof line 124. In the illustrated embodiment, the housing 102 is mounted such that a lower side 124 of the housing 102 is positioned to be substantially even with, or in some cases somewhat above or below, a bottom edge of the front roof fascia board 118. In this way, the housing 102 can be substantially or partially obscured from view by persons looking at the house, while providing a substantial viewing area of the light sheet 108. In some embodiments, the housing 102 is positioned so that none of the housing 102, sheet 108, rod 112, or other components are generally visible upon casual observation when the sheet 108 is retracted.

Mounting brackets 104 can be shaped or structured in many different ways, for example, to permit the housing 102 to be connected to the rafter tail 122 rather than, or in addition to, the front roof fascia 118.

The lighting sheet 108 can have a background color that is white, beige, black, or some other color or shade, or optionally, the lighting sheet can be partially or substantially clear. In some embodiments, the sheet 108 can be made of felt or felt-like material, and/or can be flexible to permit easy winding and unwinding, but strong, heavy, and durable enough to be substantially wrinkle-free and to unwind easily under its own weight optionally in conjunction with the weight of the rod 112. The sheet 108 can be made of a material that resists damage caused by water, UV rays, and/or thermal change.

FIG. 4 illustrates an example of the lighting device 100 and a manual lighting actuator tool 126. The tool 126 can have a first proximal portion 128 proximal to the user, and a second distal portion 130 distal from the user. The proximal portion 128 can include a first hand grip portion 132 and a second hand grip portion 134. The tool 126 can also include an actuator 136, such as a hand crank or other structure, for turning a rod, band, wire, or other structure that extends within the tool 126 to the distal end 138 of the tool 126. In some embodiments, the hand grips 132, 134 can be held by the user's hands to position the distal end 138 of the tool 126 in close proximity to or coupled with the tool port 114. When connected to the lighting device 100, the actuator 136 can be manually turned to spin the tool port 114, which in turn spins the rod 110 and makes the lighting sheet 108 wind or unwind as desired. In some embodiments, a tool 126 can be capable of telescoping selectively so that it can be configured to have various lengths to accommodate various height positions of the mounted lighting devices 100. In some embodiments of the tool 126 with a telescoping function, the hand grip 134 can be turned clockwise or counterclockwise (or moved in some other way) to permit the distal portion 130 and the proximal portion 128 to come together or move apart so as to contract or lengthen the overall size of the tool 126. Many other types of tools can be employed to selectively obscure or reveal the lighting sheet 108, including tools that are partially manual and partially electrical, including tools with a motor for spinning the tool port 114.

In some embodiments, the housing 102 of the lighting device 100 and/or the sheet 108 can be configured to include a spring-lock or other structure for permitting the sheet to pull down and remain down for a period and then allowing the sheet to automatically retract when it is pulled down further a short distance, as with a window shade or movie sheet. In such embodiments, the rod 112 may be configured with a hook or a hole or other structure to interface with an appropriate tool 126 for pulling down the sheet to make it come out, or to pull it an additional distance to make it retract. These embodiments may, or may not, include a tool port 114.

The vertical length L of the sheet 108 when fully exposed can have many different sizes. In some embodiments, L can be relatively small, such as less than about 1 inch, or between about 1 inch and about 3 inches, or between about 3 inches and about 5 inches, or less than about 5 inches. In other embodiments, L can be larger, such as greater than about 5 inches, or between about 5 inches and about 7 inches, or between about 7 inches and about 9 inches, or larger than about 9 inches. In some embodiments, the exposed length L of the sheet 108 can be modified by selectively winding or unwinding less than the full sheet 108 to permit selective displaying of only certain portions of the lighting components on the sheet 108. In addition, in embodiments with motorized mechanisms for exposing or obscuring the lighting, the sheet 108 can be caused to come out or retract into the housing 102 during an animation or other timed display, such as a display that is synchronized with music.

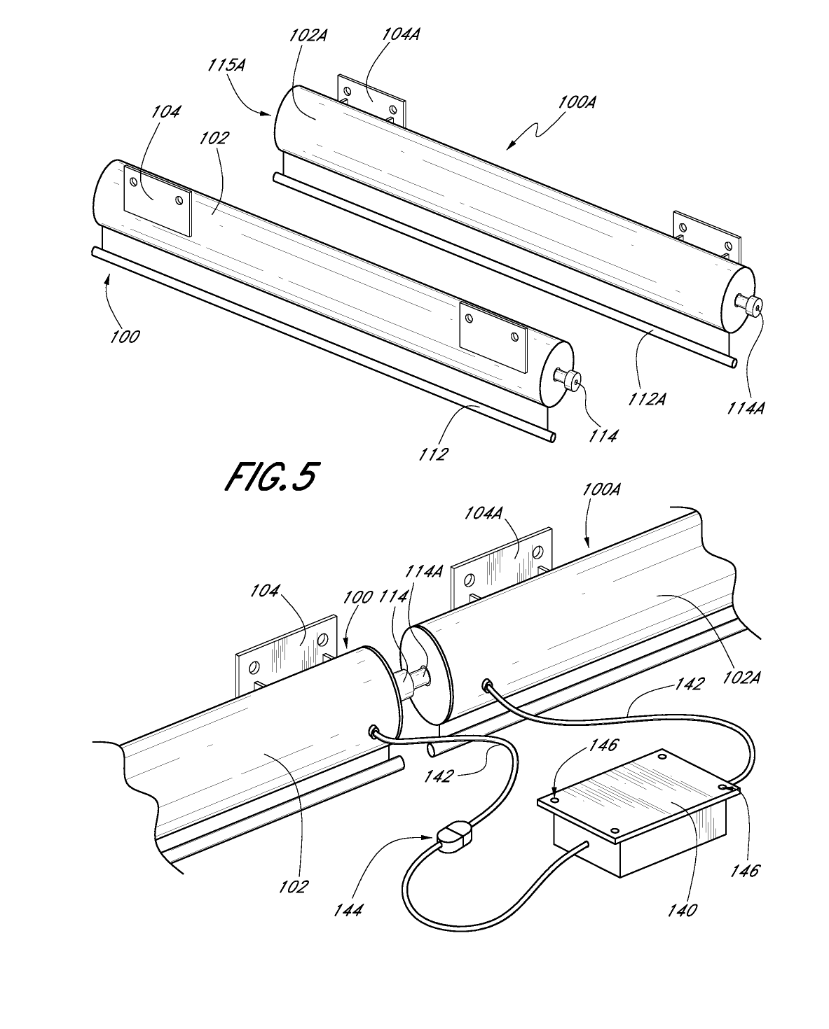

FIG. 5 illustrates an example of two lighting devices 100, 100A. These devices can include components similar to or the same as the devices illustrated in FIGS. 1-4. One of these devices 102A is configured to be mounted adjacent to and/or to connect with the other device 100. The device 100A includes a male portion 114A for interfacing with the tool port 114 of the other device 100. When the devices 100, 100A are mounted adjacent to each other substantially along their respective longitudinal axis, as shown, the male member 114A of one device 100A can be inserted into the tool port 114 of the other device 100. The respective mounting brackets 104, 104A can secure the devices 100, 100A in this orientation. A rotatable connection can be provided between the lighting devices 100, 100A in many different ways, such as by rotating cords, wires, or synchronized motors, which may in some embodiments allow the lighting devices 100, 100A to be positioned further from each other or at slightly or substantially different angular orientations or positions.

In some embodiments, a tool port 114 can be provided on one end of both devices 100, 100A and a male portion 114A can be provided on the other end of both devices 100A. In this way, multiple devices 100, 100A can be positioned together, essentially in a line or other jointly rotatable configuration, to permit the devices 100, 100A to share a common lighting power source, and/or to be rotationally connected to permit the lighting sheet 108 contained therein to be simultaneously wound or unwound without requiring actuation of each individual lighting device 100, 100A.

A power supply 140 can be attached by wires 142 to each of the lighting devices 100, 100A. The power supply 140 can be a transformer connected to an AC power supply system of a house by way of an electrical wire (not shown). In some embodiments, a single power supply 140 can be positioned near an outlet of the house electrical system and the power supply 140 can be electrically connected to each of the lighting devices by way of low-voltage connections. In some embodiments, the power supply can be permanently connected to one of the devices 100A, but only temporarily connected to the other device 100 by way of a removable connector 144. In some embodiments, such as when the power supply 140 is a transformer, the wires 142 may carry very low voltage, making the lighting system safer. The power supply 140 can be provided with mounting holes 146 for receiving screws, nails, staples, or other connecting structures to attach the power supply 140 to an appropriate place on the house. In some embodiments, the wires 142 and power supply 140 are mounted in a manner that obscures them from the view of one who is looking at the house. In some embodiments, such as the embodiments of FIG. 1, each of the lighting devices 100, 200, 300, 400, can be wired together so that a single power source or synchronized power sources can provide power and/or control all of the lighting devices.

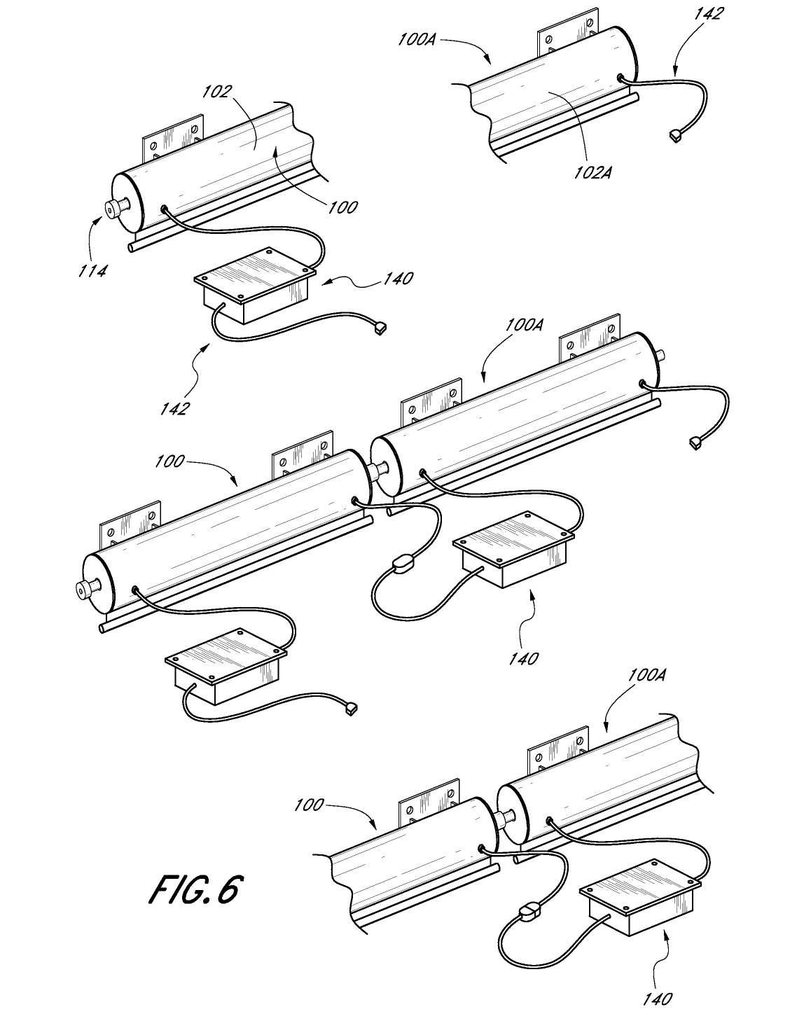

FIG. 6 illustrates examples of the lighting devices 100, 100A before and after coupling. The power supply 140 can be positioned, oriented, and configured in many different ways. For example, the power supply 140 can be positioned adjacent to the electrical outlet in the home, and low-voltage wire can be connected to each of the lighting devices 100, 100A mounted to the house, with only one power supply. The power supply 140 can be mounted outside of the housing 102, 102A, as shown, or can be mounted in an appropriate place inside of the housing 102, 102A. The power supply can also be attached on an end of the housing 102, 102A or at a point intermediate the ends of the housing 102, 102A. If the lighting devices are being used on an automotive vehicle or other structure without an AC power source, an appropriate power supply can be provided so that the lighting devices can operate on a different electrical system. In appropriate circumstances, the power supply 140 can be a direct current power supply, such as a battery pack.

In some embodiments, the lighting sheet 108 and/or lighting components 101 can be programmed or controlled by a processor to selectively turn lights on or off, or display different colors of lights, at random intervals or specified points and/or time intervals. This can be used to produce text messages, animations, or interesting designs, shapes, or color displays, for example. In some embodiments, a processor is included with each lighting device 100, 100A, or a central processor is operably connected by way of wires or wireless communication to each of the lighting devices 100, 100A, and/or a personal computer is operably connected to the lighting devices 100, 100A.

In appropriate configurations, a removable memory device can be inserted into a receiving juncture operably connected to one or more of the lighting devices 100, 100A. Such a removable memory device can be inserted into a personal computer or other device with appropriate software for programming animations or other lighting displays, and the information relating thereto can be stored on the removable memory device. The removable memory device can be removed from the personal computer or other device, and connected to a controller of the lighting devices 100, 100A to effectively transfer lighting control information from the personal computer to the lighting device. Remote controls units of various types can also be employed to actuate selectively the lighting sheets 108 and/or power on or off the lighting components 101, or portions thereon.

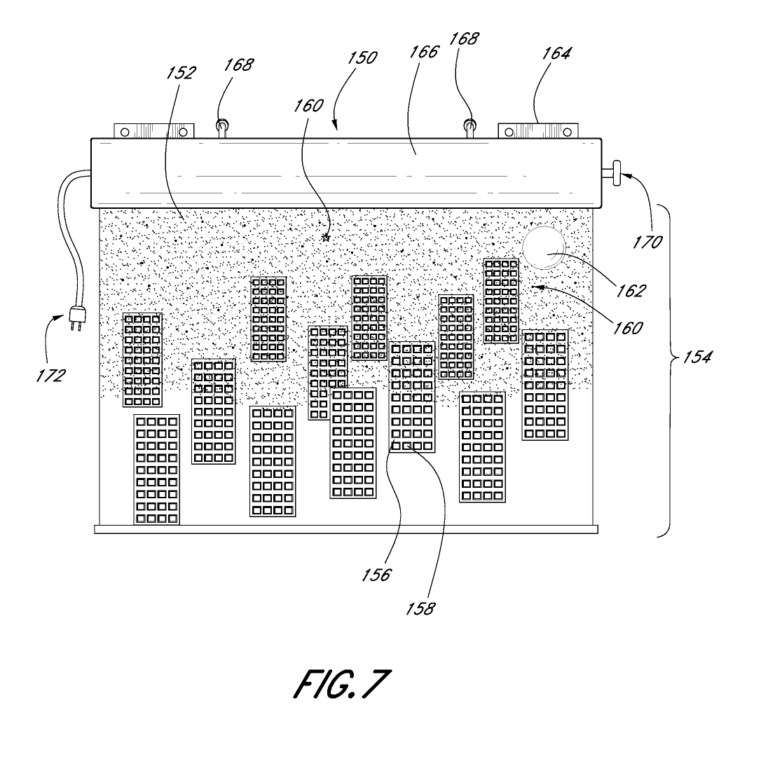

FIG. 7 illustrates an example of a lighting device 150 with a picture 154 included on the lighting sheet 152. This lighting device 150 can be especially appropriate for indoor use to help simulate a window on a wall or to enhance the appearance of an existing window. The picture 154 can include a background illustration portion 156 that is not illuminated in some embodiments. In the illustrated embodiment, the non-illuminated portion comprises an illustration of buildings. The picture 154 can also include various illuminated portions such as windows 158 on the buildings, stars 160, and/or the moon 162. Many other illuminated portions could be used such as fireworks, lightning, airplanes, etc. The illuminated portions can be configured to change shape, color, and/or position, and/or to selectively or randomly turn on or off, or to increase or decrease the intensity of the light emitted therefrom.

In some embodiments, all or substantially all of the picture 154 can be formed of an illuminated portion. The illuminated portions can be electronically coupled to a controller (not shown) positioned within or outside of the housing 166 for controlling the supply of electrical power to all or selected areas of the illuminated portion. A controller can also be configured to produce animations using the illuminated portion, and/or to activate or deactivate the illuminated portion at specific times or in response to other inputs such as the level of ambient light.

All of the structures and methods provided in this application for other embodiments of lighting devices can be used with the lighting device 150 of FIG. 7 or other related structures. Mounting devices (such as brackets 164) can be oriented in a substantially upward direction to facilitate mounting the housing 166 against a flat wall or window frame in such a way that the lighting sheet 152 can hang down against the wall and/or cover all or a portion of a window on which the sheet 152 is positioned. A suction mounting device 168 can also be used to temporarily attach the housing 166 to a suitable smooth surface such as window glass. The lighting sheet 152 can also be mounted directly to another structure, such as walls, windows, or frames, without requiring a housing 166.

An actuation or deployment device, such as a knob 170, can be provided to allow manual rolling down or rolling up of the lighting sheet 152. All of the other means for actuating or deploying the sheet 152 disclosed herein or known by those of skill in the art can also be used. A power cord 172 can be provided for conveying electrical power to the lighting device 150 from a standard household electrical system. Electrical power can also be provided in other ways, such as from batteries or solar power.

In some embodiments, the background and/or illuminated portion can be configured to change over time in a random or predetermined way. Also, a variety of different types of illustrations such as different city skylines, outer space views, or nature scenes, can be displayed and/or changed on command.

The dimensions of the lighting sheet 152 can be approximately the same as those of standard windows. Many different sizes that are smaller or larger than standard windows can also be used.

The background and/or illuminated portion can also include simulated window frame structures, such as cross members or blinds to enhance the appearance of a view through a real window. The visual appearance provided by the lighting device 150 can also be enhanced by providing corresponding sounds. These sounds can be emitted from or controlled by the electrical controller. The sounds can be associated with the particular illustrated picture 154.

The examples shown in the drawings of this application and described in the text are not intended to be limiting, but merely to illustrate various aspects of certain embodiments of these inventions. Many other alternatives and configurations are possible, and are encompassed by this disclosure. Moreover, each of the components and features described herein with respect to each embodiment can be used in other embodiments of this disclosure to form additional embodiments not expressly illustrated or described. All distances, lengths, materials, and other exemplary features of these inventions are provided for purposes of illustration only.

The system of permanent or semi-permanent installation of lighting devices illustrated and described herein can be manufactured, installed, and sold in many ways. Because the initial installation can be, in some instances, more complicated and labor intensive than the annual or periodic installation of traditional holiday lighting, the installation can in some circumstances be accomplished by professionals. The installation can be performed when the house is constructed, and offered as an optional feature to a new homeowner, or provided after the house is completed.

The modular composition of some embodiments of the lighting system disclosed herein permits a seller or installer of these devices to carry a limited set of lengths and types of lighting devices 100, 100A that can be used in many different configurations to achieve a custom fit on many different homes and other structures with various shapes and sizes. This permits lighting to be installed rapidly without waiting for custom components on many different types of homes. This feature can be especially helpful during holiday seasons, when many people desire to add lighting systems to their homes during a very short period of time.

What is claimed is:

1. A lighting device comprising:
at least one sheet;
a plurality of lighting components on the at least one sheet; and
a mounting device adapted for securing the lighting device to a surface;
wherein the lighting device is configured to position the sheet in multiple positions comprising:
a deployed position wherein the lighting components are substantially visible; and
a retracted position wherein the lighting components are substantially obscured.

2. The lighting device of claim 1, wherein the device is configured for attachment to a building or vehicle.

3. The lighting device of claim 1, wherein the lighting device is configured to move the sheet between the retracted position and deployed position by winding or unwinding the sheet.

4. The lighting device of claim 1, further comprising a housing, wherein the lighting components are substantially contained within the housing when the lighting components are in the retracted position.

5. The lighting device of claim 1, further comprising a tool port, wherein movement between the retracted position and the deployed position is actuated by use of a tool interfaced with the tool port.

6. The lighting device of claim 5, wherein the tool is an extended instrument.

7. The lighting device of claim 1, further comprising a motor, wherein the motor supplies power for movement between the retracted position and the deployed position.

8. The lighting device of claim 1, hereinafter referred to as the first lighting device, further comprising a connector, the connector capable of establishing a connection between the first lighting device and a second lighting device, the second lighting device comprising a plurality of moveable lighting components, wherein the connection provides for substantially joint movement of the lighting components of the second lighting device with the movement of the lighting components of the first lighting device.

9. The lighting device of claim 1, further comprising a receiving juncture, wherein the receiving juncture is configured to accept a removable memory device, and wherein the removable memory device stores information for controlling the operation of at least some of the plurality of lighting components.

10. The lighting device of claim 1, wherein the sheet additionally comprises a picture.

11. The lighting device of claim 10, wherein a portion of the picture is not formed by the lighting components.

12. The lighting device of claim 10, wherein a portion of the picture is formed by the lighting components.

13. A lighting device comprising:
a plurality of lighting components;
a rotatable component; and
a mounting device adapted for securing the lighting device to a surface;
wherein the plurality of lighting components are positionable in multiple positions comprising:
a deployed position wherein the lighting components are substantially viewable; and
a retracted position wherein the lighting components are substantially obscured; and
wherein the rotatable component is configured to move the lighting components between the retracted position and deployed position by winding or unwinding the lighting components.

14. The lighting device of claim 13, wherein the device is configured for attachment to a building or vehicle.

15. The lighting device of claim 13, further comprising a housing, wherein the lighting components are substantially contained within the housing when the lighting components are in the retracted position.

16. The lighting device of claim 13, further comprising a tool port, wherein movement between the retracted position and the deployed position is actuated by use of a tool interfaced with the tool port.

17. The lighting device of claim 16, wherein the tool is an extended instrument.

18. The lighting device of claim 13, further comprising a motor, wherein the motor supplies power for movement between the retracted position and the deployed position.

19. The lighting device of claim 13, hereinafter referred to as the first lighting device, further comprising a connector, the connector capable of establishing a connection between the first lighting device and a second lighting device, the second lighting device comprising a plurality of moveable lighting components, wherein the connection provides for substantially joint movement of the lighting components of the second lighting device with the movement of the lighting components of the first lighting device.

20. The lighting device of claim 13, further comprising a receiving juncture, wherein the receiving juncture is configured to accept a removable memory device, and wherein the removable memory device stores information for controlling the operation of at least some of the plurality of lighting components.

21. A method for concealing lighting components mounted on a structure or vehicle comprising selectively winding and unwinding the lighting components around a rotatable component.
